(19) United States
(12) Patent Application Publication
(10) Pub. No.: US 2016/0232373 A1
(43) Pub. Date: Aug. 11, 2016

(54) METHOD AND APPARATUS FOR PROVIDING SECURITY INFORMATION OF USER DEVICE

(71) Applicant: Alibaba Group Holding Limited, Grand Cayman (KY)

(72) Inventors: Aiqing Chen, Hangzhou (CN); Long Lai, Hangzhou (CN)

(21) Appl. No.: 15/016,966

(22) Filed: Feb. 5, 2016

(30) Foreign Application Priority Data
Feb. 7, 2015 (CN) 201510068083.2

(51) Int. Cl. G06F 21/62; G06Q 20/10

(52) U.S. Cl. CPC G06F 21/6218; G06Q 20/10

(57) ABSTRACT

A method and an apparatus for providing security information of a user device are disclosed. The method includes obtaining security information of a user device; determining corresponding security display information based on the security information, the security display information including a security curve corresponding to the security information; and displaying the security display information to the user device. The present disclosure provides an intuitive and clear way of presenting security information, which not only enhances an efficiency of obtaining the security information by a user and improves use experience of the user, but also overcomes a technical bias of an ordinary user to ignore the security information due to the unintelligibility of the security information, thus facilitating and drawing an attention of the user on a security status of the user device and effectively ensuring the security of user information.

### CROSS REFERENCE TO RELATED PATENT APPLICATION

This application claims foreign priority to Chinese Patent Application No. 201510068083.2 filed on Feb. 7, 2015, entitled “Method and Apparatus for Providing Security Information of User Device”, which is hereby incorporated by reference in its entirety.

### TECHNICAL FIELD

The present disclosure relates to the field of computer technologies, and particularly, to technologies for providing security information associated with user devices.

### BACKGROUND

With the development of information technologies, a variety of different types of user devices having increasingly powerful functions have emerged, and have been utilized by people to store important information and implement financial transactions, for example. Therefore, information security issues for the user devices are also increasingly prominent. For example, in order to realize online transactions, various types of innovative e-commerce (i.e., electronic commerce) payment systems, such as credit cards, debit cards, stored-value cards, digital wallets, electronic cash, mobile payment platforms, and electronic checks, etc., have been recently developed. In particular, due to the rapid spread and intelligent development of intelligent terminals such as smartphones or tablets, an e-commerce payment system based on an intelligent terminal is one of the most popular topics at present. In order to implement a successful e-commerce platform, how to ensure the security of payment data (such as personal identity information, payment details, and bank information, etc.) and network payment environment (such as a network environment, an operating system of a payment terminal, etc.) is a crucial issue.

An intelligent terminal is used as an example. When an intelligent terminal such as a mobile phone is used for making a payment, a mobile operating system (such as iOS™, Android™, and Windows Phone™) is installed in the intelligent terminal. A number of applications (APP) can be installed on this operating system platform to extend functionalities of the intelligent terminal. A mobile payment platform APP is a type of application software, and a user can conduct an online payment of the mobile terminal via such mobile payment platform APP. However, intelligent terminals may inevitably also be prone to easy intrusion of viruses and malicious software, leading to the leakage of private data including calls, text messages and contacts, etc., of respective users. Especially, when a payment function is implemented using a mobile phone intelligent terminal, a payment program is usually installed in an ordinary system. When performing an online payment of a mobile terminal via a mobile payment platform APP, a user needs to input various types of information which includes a username, a login password, account information of a payment bank card (including a saving card, a credit card, an electronic card coupon, etc.), a payment password, and the like, which are prone to risks such as an account theft due to a relatively low security of a network payment environment of the intelligent terminal.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

An objective of the present disclosure is to provide a method and an apparatus for providing security information of a user device.

According to an aspect of the present disclosure, a method for providing security information of a user device is provided, which may include obtaining security information of a user device; determining corresponding security display information based on the security information, the security display information including a security curve corresponding to the security information; and displaying the security display information in the user device.

According to another aspect of the present disclosure, an apparatus for providing security information of a user device is provided, which may include a first apparatus to obtain security information of a user device; a second apparatus to determine corresponding security display information based on the security information, wherein the security display information includes a security curve corresponding to the security information; and a third apparatus to display the security display information in the user device.

According to another aspect of the present disclosure, an electronic apparatus is provided, which may include a display, processor(s), and a storage device configured to store a security application, the security application displaying security display information in at least a portion of display region of the display when executed by the processor(s), where the security display information includes a security curve corresponding to security information of the security application.

In an aspect, the present disclosure further provides a method of dynamically displaying network payment information, which may include starting a network payment client terminal of an intelligent terminal and entering a network payment environment; performing a real-time security detection on item(s) of detection that is/are related to network payment security, the item(s) of detection including software that is loaded into the intelligent terminal and an account of a user for making a network payment; determining the security of the network payment environment based on a detection result of the security detection; providing a first representation curve corresponding to a safe environment and dynamically displaying the first representation curve in a display screen of the intelligent terminal in response to determining that the network payment environment is the safe environment; or providing a second representation curve corresponding to a dangerous environment and dynamically displaying the second representation curve in the display screen of the intelligent terminal in response to determining that the network payment environment is the dangerous environment.

In implementations, in an event that the software that is loaded into the intelligent terminal includes a virus software detection sub-item and a pirated software detection sub-item, performing the security detection on the software that is loaded into the intelligent terminal may include detecting whether the software that is loaded into the intelligent terminal includes virus software and/or pirated software. In implementations, in an event that the account of the user for making the network payment includes a remote login detection sub-item, a public device detection sub-item, a mobile phone binding change detection sub-item and a password modification detection sub-item, performing the security detection on the account of the user for making the network payment may include detecting whether a remote login, a public device login, a mobile phone binding change, and/or a password modification exist(s); determining that the network payment environment is the safe environment when no risk exists for all of the foregoing detection sub-items; and determining that the network payment environment is the dangerous environment in response to detecting that a risk exists for any one of the foregoing detection sub-items.

In implementations, the dynamic display method may further include setting up the first representation curve corresponding to the safe environment, an expression of the first representation curve being y=Asinx, where A>0; and setting up the second representation curve corresponding to the dangerous environment, an expression of the second representation curve being y=Bsinx, where B>0 and B>A.

In implementations, the dangerous environment may be divided into different dangerous levels based on a number and/or respective categor(ies) of detection sub-item(s) in which risk(s) is/are detected.

In implementations, the second representation curve changes with a dangerous level of the dangerous environment, i.e., the higher the dangerous level of the dangerous environment is, the larger the magnitude of fluctuation of the second representation curve becomes.

In implementations, the dynamic display method may further include setting a first background color corresponding to the safe environment and a second background color corresponding to the dangerous environment; providing the first background color corresponding to the safe environment and displaying the first background color in the display screen of the intelligent terminal in response to determining that the network payment environment is the safe environment; and providing the second background color corresponding to the dangerous environment and displaying the second background color in the display screen of the intelligent terminal in response to determining that the network payment environment is the dangerous environment.

In implementations, the dynamic display method may further include performing a real-time detection on transaction data and/or the network payment environment running in the network payment client terminal, and issuing updated information and dynamically displaying the updated information above the first representation curve or the second representation curve upon detecting a new change.

In implementations, the dynamic display method may further include performing a real-time detection on transaction data and/or the network payment environment running in the network payment client terminal, and issuing updated information, displaying the updated information above the first representation curve or the second representation curve, and dynamically moving the updated information from a position above the first representation curve or the second representation curve to a position below the first representation curve or the second representation curve in response to detecting a new change.

In implementations, the dynamic display method may further include converting the first representation curve and the second representation curve into a Bézier curve as a trajectory of a touch-screen operation; upon detecting that the first representation curve or the second representation curve is pulled, hiding page information and exposing the updated information; and upon detecting that the first representation curve or the second representation curve is restored, restoring an original interface and displaying the updated information in the original interface.

In implementations, the dynamic display method may further include restarting the security detection on the detection items related to the network payment security and determining the security of the network payment environment based on a corresponding detection result of the restarted security detection, in response to detecting that the first representation curve or the second representation curve is restored after being pulled.

In implementations, the Bézier curve is a quadratic Bézier curve, and a control point of the quadratic Bézier curve is located below the quadratic Bézier curve.

In another aspect, the present disclosure further provides a system for dynamically displaying network payment information, which may include an activation unit configured to activate a network payment client terminal of an intelligent terminal and enter a network payment environment; a security detection unit connected to the start unit and configured to perform a real-time security detection on detection item(s) related to network payment security, the detection item(s) including software that is loaded into the intelligent terminal and an account of a user for making a network payment; a security determination unit connected to the security detection unit and configured to determine the security of a network payment environment based on a detection result of the security detection; a dynamic display unit connected to the security determination unit and configured to provide a corresponding representation curve for dynamically displaying according to the security of the network payment environment determined by the security determination unit, i.e., provide a first representation curve corresponding to a safe environment and dynamically display the first representation curve in a display screen of the intelligent terminal in response to determining that the network payment environment is the safe environment, and provide a second representation curve corresponding to a dangerous environment and dynamically display the second representation curve in the display screen of the intelligent terminal in response to determining that the network payment environment is the dangerous environment.

In implementations, in an event that the software that is loaded into the intelligent terminal includes a virus software detection sub-item and a pirated software detection sub-item, performing the security detection on the software that is loaded into the intelligent terminal may include detecting whether the software that is loaded into the intelligent terminal includes virus software and/or pirated software. In implementations, in an event that the account of the user for making the network payment includes a remote login detection sub-item, a public device detection sub-item, a mobile phone binding change detection sub-item and a password modification detection sub-item, performing the security detection on the account of the user for making the network payment may include detecting whether a remote login, a public device login, a mobile phone binding change, and/or a password modification exist(s); determining that the network payment environment is the safe environment when no risk exists for all of the foregoing detection sub-items; and determining that the network payment environment is the dangerous environment in response to detecting that a risk exists for any one of the foregoing detection sub-items.

In implementations, the dynamic display system may further include a representation curve setting unit configured to set up a first representation curve corresponding to the safe environment and a second representation curve corresponding to the dangerous environment, where an expression of the first representation curve is y=Asinx, and an expression of the second representation curve is y=Bsinx, in which A>0, B>0 and B>A.

In implementations, the dangerous environment is divided into different dangerous levels according to a number and/or respective categor(ies) of detection sub-item(s) in which risks is/are detected.

In implementations, the second representation curve changes over a dangerous level of the dangerous environment, i.e., the higher the dangerous level of the dangerous environment is, the larger the amplitude of fluctuation of the second representation curve becomes.

In implementations, the dynamic display system may further include a background color setting unit configured to set a first background color corresponding to the safe environment and a second background color corresponding to the dangerous environment. In response to the security determination unit determining that the network payment environment is the safe environment, the background color setting unit provides the first background color corresponding to the safe environment and the dynamic display unit displays the first background color in the display screen of the intelligent terminal. In response to the security determination unit determining that the network payment environment is the dangerous environment, the background color setting unit provides the second background color corresponding to the dangerous environment and the dynamic display unit displays the second background color in the display screen of the intelligent terminal.

In implementations, the dynamic display unit may further issue updated information and display the updated information above the first representation curve or the second representation curve dynamically upon detecting a new change after the security detection unit performs a real-time detection on transaction data and/or the network payment environment running in the network payment client terminal.

In implementations, the dynamic display unit may further issue updated information, display the updated information above the first representation curve or the second representation curve, and dynamically move the updated information from a position above the first representation curve or the second representation curve to a position below the first representation curve or the second representation curve upon detecting a new change, after the security detection unit performs a real-time detection on transaction data and/or the network payment environment running in the network payment client terminal.

In implementations, the representation curve setting unit may further convert the first representation curve and the second representation curve into a Bézier curve as a trajectory of a touch-screen operation. The dynamic display system may further include a location detection unit that is configured to detect whether the first representation curve or the second representation curve is pulled. When the location detection unit detects that the first representation curve or the second representation curve is pulled, the dynamic display unit thereby displays a change state after the first representation curve or the second representation curve is pulled, hides page information, and exposes the updated information. When the location detection unit detects that the first representation curve or the second representation curve is restored, the dynamic display unit thereby displays a change state after the first representation curve or the second representation curve is restored, restores an original interface and displays the updated information in the original interface.

In implementations, when the location detection unit detects that the first representation curve or the second representation curve is restored after being pulled, the security detection unit restarts the security detection on the detection items related to the network payment security and the security determination unit determines the security of the network payment environment based on a detection result of the security detection performed by the security detection unit.

In implementations, the Bézier curve is a quadratic Bézier curve, and a control point of the quadratic Bézier curve is located below the quadratic Bézier curve.

Compared with existing technologies, the present disclosure determines corresponding security display information based on security information and displays the security display information, including a security curve, on a user device. This intuitive and clear way of presenting security information not only enhances an efficiency of obtaining the security information by a user and improves use experience of the user, but also overcomes a technical bias of an ordinary user to ignore the security information due to the unintelligibility of the security information, thus facilitating and drawing the attention of the user on a security status of the user device and effectively ensuring the security of user information. For example, upon being aware that a user device thereof is in an unsafe state using the present technical solution, a user may suspend performing operations on sensitive information on the device, e.g., suspend conducting a network payment on the device.

### BRIEF DESCRIPTION OF THE DRAWINGS

FIG. 1 is a schematic diagram illustrating an apparatus for providing security information of a user device according to one aspect of the present disclosure.

FIG. 2 is a schematic diagram illustrating a method for providing security information of a user device according to another aspect of the present disclosure.

FIG. 3 is a schematic diagram illustrating a system of dynamically displaying network payment information in accordance with an embodiment of the present disclosure.

FIG. 4 is a schematic diagram illustrating an exemplary dynamic presentation on a display screen of an intelligent terminal by of a system of dynamically displaying network payment information in accordance with the present disclosure.

FIG. 5 is a schematic diagram illustrating a system of dynamically displaying network payment information in accordance with another embodiment of the present disclosure.

FIGS. 6 and 7 are schematic diagrams illustrating a system of dynamically displaying network payment information in accordance with other embodiments of the present disclosure.

FIG. 8 is a schematic diagram illustrating a method of dynamically displaying network payment information in accordance with an embodiment of the present disclosure.

### DETAILED DESCRIPTION

Embodiments of the present disclosure are described using exemplary implementations herein. One skilled in the art can easily understand other advantages and efficacies of the present disclosure based on content disclosed in the present disclosure. The present disclosure can also be implemented or applied through other different exemplary implementations. Each feature in the present disclosure may also be modified or changed based on different points of view and applications, without departing from the spirit of the present disclosure.

In a typical configuration for the present disclosure, a terminal, an apparatus and a trusted party of a service network each may include one or more processors (CPUs), I/O interfaces, network interfaces, and memory. The memory may include a form of computer-readable media, e.g., a non-permanent storage device, random-access memory (RAM) and/or a nonvolatile internal storage, such as read-only memory (ROM) or flash RAM. The memory is an example of computer-readable media. The computer-readable media may include a permanent or non-permanent type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer-readable media does not include transitory media, such as modulated data signals and carrier waves.

Accompanying drawings are referenced. It should be noted that the drawings provided in the embodiments herein are merely used to illustrate basic concepts of the present disclosure in a schematic manner. As such, the drawings merely demonstrates relevant components in the present disclosure, instead of being drawn according to number(s), shape(s), and size(s) of components when being implemented in practice. Respective types, numbers, and ratios of the components when being implemented in practice may be varied arbitrarily, and a type of layout of the components may be more complicated.

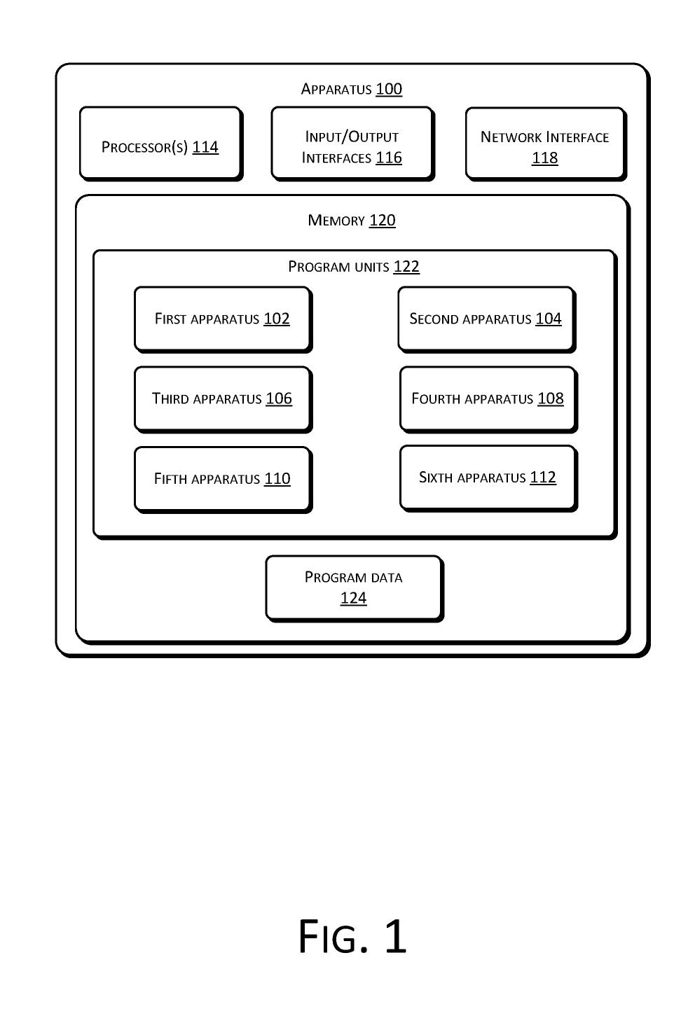

FIG. 1 shows an apparatus 100 for providing security information of a user device. In implementations, the apparatus 100 may include a first apparatus 102, a second apparatus 104, and a third apparatus 106. The first apparatus 102 obtains security information of a user device. The second apparatus 104 determines corresponding security display information based on the security information, where the security display information includes a security curve corresponding to the security information. The third apparatus 106 displays the security display information to the user device.

In implementations, the first apparatus 102 may read security information of the user device directly from other security modules of the user device or perform real-time detection on the user device, for example scanning whether security vulnerabilities exist or malicious Trojans are installed in the user device, etc., based on a check list. The security information may include, but is not limited to, whether the user device is safe, a security level associated with the user device, what security vulnerabilities exist in the user device, etc.

In implementations, the second apparatus 104 may determine corresponding security display information based on the security information obtained by the first apparatus 102. In implementations, the security display information may include a security curve corresponding to the security information. For example, the second apparatus 104 may perform a mapping to obtain a sine curve (y=sinx) or a cosine curve (y=cosx) as a security curve based on the security information. In implementations, the security display information may further include display background information corresponding to the security information. By way of example and not limitation, when the security information is secure, the display background information may employ a blue shade or sparse texture. When a danger exists in the security information, the display background information may employ a red-shade or dense texture. In implementations, amplitude information and/or frequency information of the security curve corresponds to the security information. For example, when the security information is more dangerous, the security curve's amplitude information, frequency information or both is higher. When the security information is more secure, the security curve's amplitude information, the frequency information or both is lower. One skilled in the art should understand that both a selection of display background information and a configuration of amplitude and/or frequency of a security curve can enable a user to intuitively understand a current security state of a user device, so as to overcome a technical bias of an ordinary user to ignore security information due to an unintelligibility of the security information, and to facilitate and draw the user's attention on the security state of the user device to effectively ensure the security of user information. For example, upon being aware that a user device thereof is in an unsafe state using the present technical solution, a user may suspend performing operations on sensitive information on the device, e.g., suspend conducting a network payment on the device.

Furthermore, the third apparatus 106 displays the security display information in the user device. For example, if the second apparatus 104 determines that the security display information corresponding to the security information includes a cosine curve, the third apparatus 106 may invoke a corresponding image processing sub-module to draw and display the security display information in a display screen of the user device, with the security display information including the cosine curve. Alternatively, when the security display information further includes blue-shade display background information, the third apparatus 106 may display the cosine curve in a blue-shade background in the display screen.

In implementations, the apparatus 100 may further include a fourth apparatus 108 and a fifth apparatus 110 as shown in FIG. 1. The fourth apparatus 108 may obtain a user operation associated with the security curve, and the fifth apparatus 110 may perform a corresponding security processing operation according to the user operation. By way of example and not limitation, the fourth apparatus 108 may obtain a user operation on the security curve performed by the user via an interactive peripheral such as a touch screen or a mouse (e.g., dragging or sliding the security curve) through a human-machine interaction interface. The fifth apparatus 110 may determine and perform a security processing operation (such as refreshing the security information of the user device or examining more security information) corresponding to the user operation based on the user operation obtained by the fourth apparatus 108. A correspondence relationship between the user operation and the security processing operation may be predefined in the present solution. For example, when a user selects and drags the security curve, a corresponding security processing operation may be defined to include examining more security information. Additionally or alternatively, the correspondence relationship between the user operation and the security processing operation may be added or modified by the user. For example, the user may set that the corresponding security processing operation includes refreshing the security information of the user device when sliding over the security curve.

In implementations, when the user operation corresponds to an operation of refreshing information, the fifth apparatus 110 may update the security information and display the updated security display information corresponding to the security information. Alternatively, when the user operation corresponds to an operation of switching information, the fifth apparatus 110 may switch and display at least a portion of information in the security display information. An approach of switching and displaying at least a portion of information in the security display information by the fifth apparatus 110 may include, but is not limited to:

1) hiding at least a part of information that is displayed in the security display information, e.g., hiding a part of information that is displayed in the security display information by the fifth apparatus 110 when the user operation corresponds to an operation of switching information;

2) displaying at least a part of information that is not displayed in the security display information, e.g., additionally displaying a part of information that is not displayed in the security display information by the fifth apparatus 110 when the user operation corresponding to an operation of switching information; or

3) replacing at least a part of information that is displayed in the security display information by at least a part of information that is not displayed in the security display information, e.g., replacing a part of information that is displayed in the security display information by a part of information that is not displayed by the fifth apparatus 110 when the user operation corresponding to an operation of switching information.

In implementations, the fifth apparatus 110 may further generate an operation indication curve based on the user operation and the security curve, and display the operation indication curve in a display window corresponding to the security display information. For example, when a user drags the security curve, the fifth apparatus 110 may generate an operation indication curve, such as a Bézier curve, due to the dragging operation, and display the operation indication curve in a display window where the security display information is located. For another example, the fifth apparatus 110 may further display a portion of information that is newly added and has not been displayed in the security display information on an arc line of the operation indication curve. One skilled in the art should understand that a corresponding Bézier curve may be generated using drawing function(s), such as a function of CGContextAddQuadCurveToPoint, of the existing Bézier curve and based on endpoint(s) of the original security curve and a control point moved by the user operation.

In implementations, the apparatus 100 may further include a sixth apparatus 112 as shown in FIG. 1. The sixth apparatus 112 may obtain security event information, generate security prompt information corresponding to the security event information, and display the security prompt information in a display window corresponding to the security display information. In implementations, the sixth apparatus 112 may obtain the security event information of the user device, for example, by employing an event message mechanism or accessing event log information, such as a transaction payment completed by a user via the user device or other related security events. The sixth apparatus 112 may generate the security prompt information corresponding to the security event information by generating an abstract or extracting keyword(s) based on event description information, for example. The sixth apparatus 112 may display the security prompt information in a display window corresponding to the security display information, for example, when the user device completes a transaction payment event, the security prompt information, such as “a new transaction payment is added” or other similar information, is displayed in a display window corresponding to the security display information.

In implementations, the security prompt information may be displayed in a corresponding item in the display window. For example, the security display information is displayed as one or more items in the window. Accordingly, the sixth apparatus 112 may determine a corresponding item of the security prompt information in the display window, and display the security prompt information in the corresponding item in the display window.

In implementations, the security prompt information may be displayed in the display window with a refresh frequency corresponding to the security event information. For example, the security prompt information “flash” appears in the display window, with a “flash” frequency or a refresh frequency corresponding to the security event information. For example, when the security event information has a high risk or importance, the “flash” frequency is higher. In implementations, the security prompt information is displayed in the display window with a refresh frequency corresponding to the security event information.

In implementations, the apparatus 100 may further include one or more processors 114, an input/output (I/O) interface 116, a network interface 118 and memory 120. The memory 120 may include a form of computer-readable media, e.g., a non-permanent storage device, random-access memory (RAM) and/or a nonvolatile internal storage, such as read-only memory (ROM) or flash RAM. The memory 120 is an example of computer-readable media as described in the foregoing description. The memory 120 may include program units 122 and program data 124. The program units 122 may include one or more of the apparatuses 102-112 as described in the foregoing embodiments.

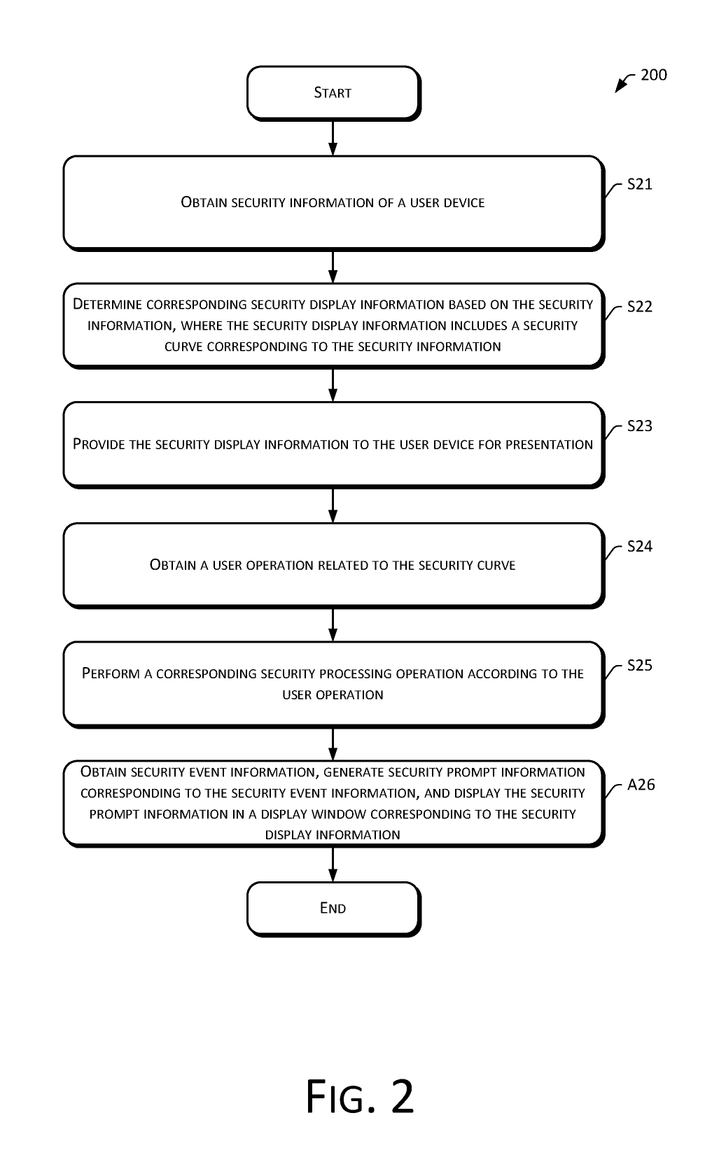

FIG. 2 shows a flowchart of a method 200 for providing security information of a user device. The method 200 may include S21, S22, and S23. At S21, the apparatus 100 obtains security information of a user device. At S22, the apparatus 100 determines corresponding security display information based on the security information, where the security display information includes a security curve corresponding to the security information. At S23, the apparatus 100 provides the security display information to the user device for presentation.

In implementations, at S21, the first apparatus 102 may read security information of the user device directly from other security modules of the user device or perform real-time detection on the user device, for example scanning whether security vulnerabilities exist or malicious Trojans are installed in the user device, etc., based on a check list. The security information may include, but is not limited to, whether the user device is safe, a security level associated with the user device, what security vulnerabilities exist in the user device, etc.

At S22, the apparatus 100 may determine corresponding security display information based on the security information obtained at S21, where the security display information may include a security curve corresponding to the security information. For example, at S22, the apparatus 100 may perform a mapping to obtain a sine curve (y=sinx) or a cosine curve (y=cosx) as a security curve based on the security information. In implementations, the security display information may further include display background information corresponding to the security information. By way of example and not limitation, when the security information is secure, the display background information may employ a blue shade or sparse texture. When a danger exists in the security information, the display background information may employ a red-shade or dense texture. In implementations, amplitude information and/or frequency information of the security curve corresponds to the security information. For example, when the security information is more dangerous, the security curve's amplitude information, frequency information or both is higher. When the security information is more secure, the security curve's amplitude information, the frequency information or both is lower. One skilled in the art should understand that both a selection of display background information and a configuration of amplitude and/or frequency of a security curve can enable a user to intuitively understand a current security state of a user device, so as to overcome a technical bias of an ordinary user to ignore security information due to an unintelligibility of the security information, and to facilitate and draw the user's attention on the security state of the user device to effectively ensure the security of user information. For example, upon being aware that a user device thereof is in an unsafe state using the present technical solution, a user may suspend performing operations on sensitive information on the device, e.g., suspend conducting a network payment on the device.

At S23, the apparatus 100 displays the security display information in the user device. For example, if the apparatus 100 determines that the security display information corresponding to the security information includes a cosine curve at S22, apparatus 100 may invoke a corresponding image processing sub-module to draw and display the security display information in a display screen of the user device at S23, with the security display information including the cosine curve. Alternatively, when the security display information further includes blue-shade display background information, the apparatus 100 may displays the cosine curve in a blue-shade background in the display screen at S23.

In implementations, the method 200 may further include S24 and S25. At S24, the apparatus 100 obtains a user operation about the security curve. At S25, the apparatus 100 performs a corresponding security processing operation according to the user operation. By way of example and not limitation, the apparatus 100 may obtain a user operation on the security curve performed by the user via an interactive peripheral such as a touch screen or a mouse (e.g., dragging or sliding the security curve) through a human-machine interaction interface at S24. At S25, the apparatus 100 may determine and perform a security processing operation (such as refreshing the security information of the user device or examining more security information) corresponding to the user operation based on the user operation obtained at S24. A correspondence relationship between the user operation and the security processing operation may be predefined in the present solution. For example, when a user selects and drags the security curve, a corresponding security processing operation may be defined to include examining more security information. Additionally or alternatively, the correspondence relationship between the user operation and the security processing operation may be added or modified by the user. For example, the user may set that the corresponding security processing operation includes refreshing the security information of the user device when sliding over the security curve.

In implementations, when the user operation corresponds to an operation of refreshing information, the apparatus 100 may update the security information and display updated security display information corresponding to the updated security information at S25. Alternatively, when the user operation corresponds to an operation of switching information, the apparatus 100 may switch and display at least a portion of information in the security display information at S25. At S25, an approach of switching and displaying at least a portion of information in the security display information by the apparatus 100 may include, but is not limited to:

1) hiding at least a part of information that is displayed in the security display information, e.g., hiding a part of information that is displayed in the security display information by the apparatus 100 at S25 when the user operation corresponds to an operation of switching information;

2) displaying at least a part of information that is not displayed in the security display information, e.g., additionally displaying a part of information that is not displayed in the security display information by the apparatus 100 at S25 when the user operation corresponding to an operation of switching information; or

3) replacing at least a part of information that is displayed in the security display information by at least a part of information that is not displayed in the security display information, e.g., replacing a part of information that is displayed in the security display information by a part of information that is not displayed by the apparatus 100 at S25 when the user operation corresponding to an operation of switching information.

In implementations, at S25, the apparatus 100 may further generate an operation indication curve based on the user operation and the security curve, and display the operation indication curve in a display window corresponding to the security display information. For example, when a user drags the security curve, the apparatus 100 may generate an operation indication curve, such as a Bézier curve, due to the dragging operation, and display the operation indication curve in a display window where the security display information is located at S25. For another example, the apparatus 100 may further display a portion of information that is newly added and has not been displayed in the security display information on an arc line of the operation indication curve at S25. One skilled in the art should understand that a corresponding Bézier curve may be generated using drawing function(s), such as a function of CGContextAddQuadCurveToPoint, of the existing Bézier curve and based on endpoint(s) of the original security curve and a control point moved by the user operation.

In implementations, the method 200 may further include S26. At S26, the apparatus 100 may obtain security event information, generate security prompt information corresponding to the security event information, and display the security prompt information in a display window corresponding to the security display information. For example, at S26, the apparatus 100 may obtain the security event information of the user device, for example, by employing an event message mechanism or accessing event log information, such as a transaction payment completed by a user via the user device or other related security events. The apparatus 100 may generate the security prompt information corresponding to the security event information by generating an abstract or extracting keyword(s) based on event description information, for example. The apparatus 100 may display the security prompt information in a display window corresponding to the security display information, for example, when the user device completes a transaction payment event, the security prompt information, such as “a new transaction payment is added” or other similar information, is displayed in a display window corresponding to the security display information.

In implementations, the security prompt information may be displayed in a corresponding item in the display window. For example, the security display information is displayed as one or more items in the window. Accordingly, the apparatus 100 may determine a corresponding item of the security prompt information in the display window, and display the security prompt information in the corresponding item in the display window at S26.

In implementations, the security prompt information may be displayed in the display window with a refresh frequency corresponding to the security event information. For example, the security prompt information “flash” appears in the display window, with a “flash” frequency or a refresh frequency corresponding to the security event information. For example, when the security event information has a high risk or importance, the “flash” frequency is higher. In implementations, the security prompt information is displayed in the display window with a refresh frequency corresponding to the security event information.

In order to implement the foregoing embodiments, the present disclosure further proposes an electronic apparatus. The electronic apparatus may include a display, processor(s), and a storage device configured to store a security application. The security application displays security display information in at least a portion of a display region of the display when executed by the processor(s). In implementations, the security display information may include a security curve corresponding to security information of the security application.

In implementations, security prompt information is displayed in a display window corresponding to the security display information. The security prompt information corresponds to security event information obtained by the security application.

In implementations, execution information of a security processing operation is displayed in the display window corresponding to the security display information. The security processing operation corresponds to a user operation associated with the security curve obtained by the security application.

One skilled in the art should understand that the present solution is applicable to any type of user device, and the present solution may be implemented as an independent application in a user device, or may be integrated with other applications in the user device, such as a payment application or a social application. Accordingly, “an intelligent terminal” and “a network payment” are used as an example hereinafter to further illustrate relevant embodiments of the present disclosure. One skilled in the art should understand that the present disclosure will also be applicable to other user devices or other applications.

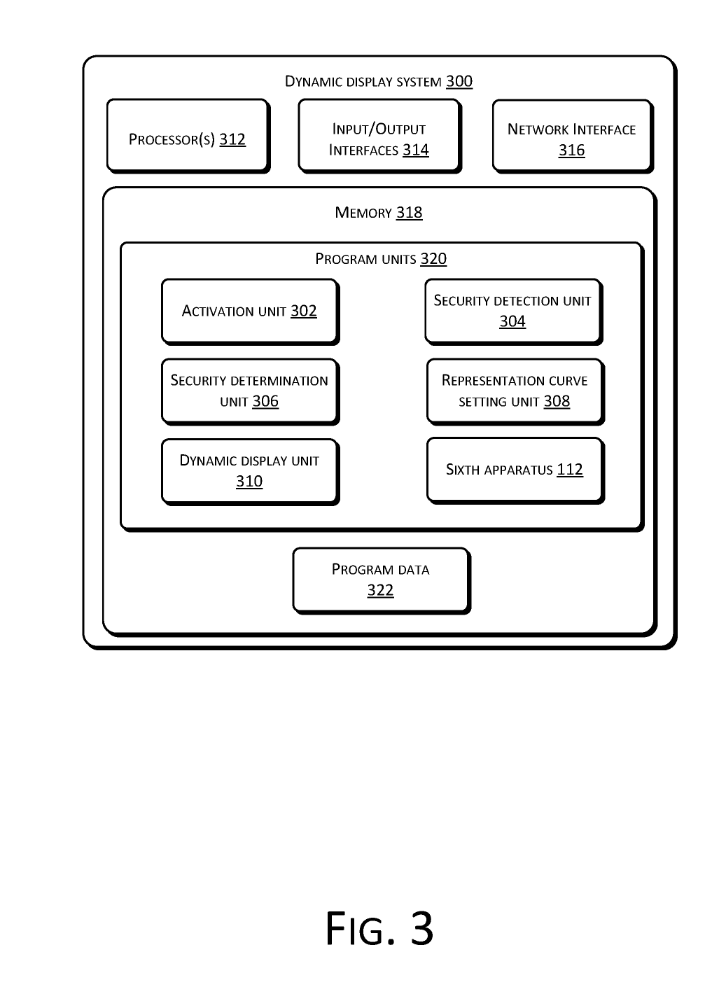

FIG. 3 shows a schematic diagram illustrating a dynamic display system 300 for network payment information in accordance with an embodiment of the present disclosure. It should be noted that the dynamic display system 300 for network payment information provided by the present disclosure is applied in an intelligent terminal, and the intelligent terminal is equipped with a network payment client for implementing a network payment in the present embodiment. The intelligent terminal is a data processing apparatus having data processing capabilities, and includes processor(s), storage device(s), display screen(s), etc. In practice, the intelligent terminal may include, for example, a smartphone, a personal digital assistant (PDA), a tablet PC, a car-mounted terminal, and even a wearable device (such as a smartwatch), and other electronic apparatuses having a touch-sensitive display screen. A smartphone is used as an example of the intelligent terminal in the following exemplary embodiments.

As shown in FIG. 3, the dynamic display system 300 for network payment information may include an activation unit 302, a security detection unit 304, a security determination unit 306, a representation curve setting unit 308, and a dynamic display unit 310.

Detailed description for these components is provided hereinafter.

The activation unit 302 is configured to activate a network payment client of an intelligent terminal to enter into a network payment environment. In the present embodiment, the intelligent terminal is equipped with a network payment client for conducting a network payment. If a mobile phone is taken as an example, a network payment client for conducting a network payment is an application software APP, i.e., a mobile payment platform APP. In practice, after a user clicks on an application icon corresponding to the mobile payment platform APP in a touch-sensitive display screen, the activation unit 302 starts the mobile payment platform APP according to the present clicking operation, and displays a corresponding payment page in the touch-sensitive display screen. In general, a network payment scenario is entered by inputting an account and a login password in the payment page.

The security detection unit 304 is connected to the activation unit 302, and is configured to perform real-time security detection on detection items related to the security of a network payment. In implementations, the detection items related to the security of the network payment may include at least software loaded in the intelligent terminal and an account of a user for making the network payment. In implementations, the software loaded in the intelligent terminal may further include a virus software detection sub-item and a pirated software detection sub-item, and the account of the user for making the network payment may further include a remote login detection sub-item, a public device detection sub-item, a mobile phone binding change detection sub-item, and a password modification detection sub-item. The security detection unit 304 is configured to perform the security detection on these six detection sub-items. In other words, performing the security detection on the software loaded in the intelligent terminal includes a detection of a presence of the virus software and/or a presence of the pirated software in the software loaded in the intelligent terminal. Performing the security detection on the account of the user for making the network payment may include a detection of a presence of a remote login, a presence of a public equipment login, a presence of a binding change of a mobile phone, and/or a presence of a password modification. Apparently, it should be noted that the present embodiment merely illustrates six detection sub-items as examples, but is not limited thereto. In reality, other necessary detection sub-items may also be adjusted or added based on characteristics of the intelligent terminal, a type and security requirement(s) of the network payment.

The security determination unit 306 is connected to the security detection unit 304, and is configured to determine the security of the network payment environment based on a detection result of the security detection. In implementations, the security determination unit 306 may make a determination based on a comprehensive result obtained after the security detection unit 304 performs the detection on the multiple sub-items that are monitored. In the present disclosure, the security of network payment environment is defined as follows: determining that the network payment environment is a safe environment when and only when the security detection unit 304 detects that no risk exists in all of the above detection sub-items (i.e., the loaded software does not include any virus software and pirated software, and none of a remote login, a public equipment login, a binding change of the mobile phone and a password modification exist); otherwise, determining that the network payment environment is a dangerous environment in response to detecting that a risk exists in any one of the above detection sub-items (i.e., a virus software and/or a pirated software exist(s) in the loaded software, a remote login, a public equipment login, a binding change of the mobile phone, and/or a password modification exist(s)). Furthermore, due to a large number of detection sub-items to be detected by the security detection unit 304, in practice, the present disclosure may further divide the dangerous environment into different danger levels based on a number and/or respective categor(ies) of the detection sub-items in which risk(s) is/are detected. For example, the more the number of detection sub-items having risks is, the higher the danger level corresponding to the dangerous environment is. Alternatively, certain one or more detection sub-items may have a higher weight. When a risk exists in any of these detection sub-items having a higher weight, the dangerous environment has a higher danger level.

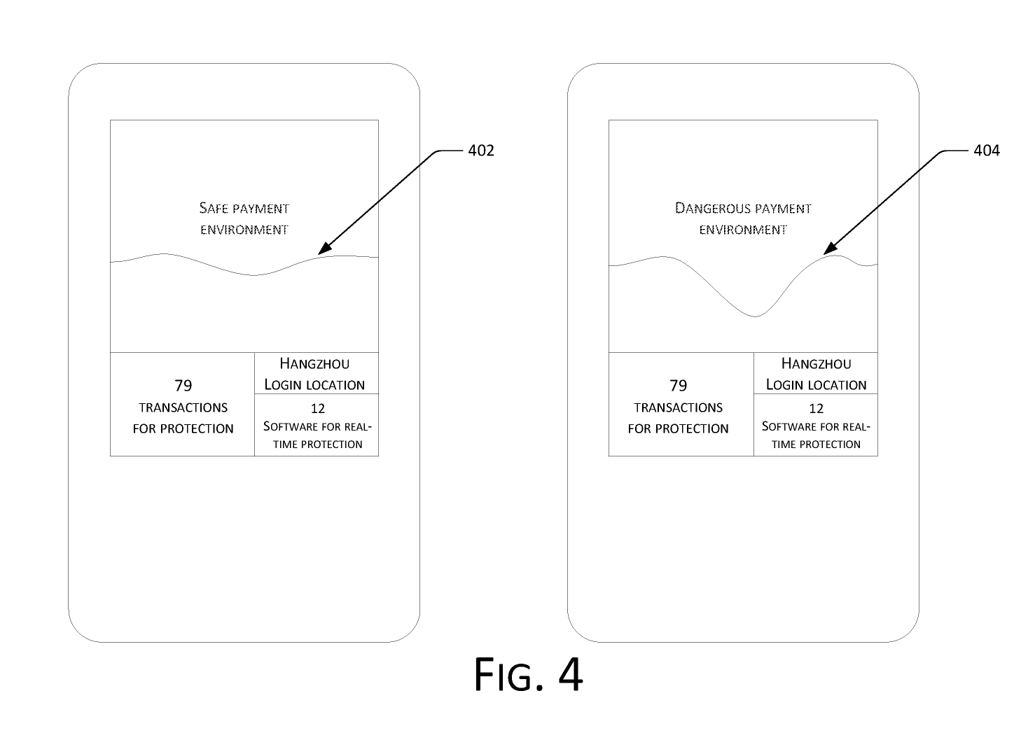

The dynamic display unit 310 is connected to the security determination unit 306, and is configured to provide a corresponding representation curve for dynamic display based on the security of the network payment environment determined by the security determination unit 306. In implementations, the dynamic display unit 310 may provide a first representation curve corresponding to a safe environment and dynamically display the first representation curve on a display screen of the intelligent terminal in response to the security determination unit 306 determining that the network payment environment is the safe environment. Additionally, in response to the security determination unit 306 determining that the network payment environment is a dangerous environment, the dynamic display unit 310 may provide a second representation curve corresponding to the dangerous environment and dynamically display the second representation curve in the display screen of the intelligent terminal. For example, FIG. 4 shows an example first representative curve 402 corresponding to a safe payment environment and an example second representative curve 404 corresponding to a dangerous payment environment in accordance with the present disclosure.

In the present disclosure, a corresponding characteristic curve is specially designed for dynamically displaying a security status of a network payment environment in real time. Therefore, the present disclosure may further include the representation curve setting unit 308, which is configured to set up a first representation curve corresponding to a safe environment and a second representation curve corresponding to a dangerous environment. In implementations, an expression of the first representation curve may be y=Asinx, and an expression of the second representation curve may be y=Bsinx, with A>0, B>0, and B>A. In this way, upon comparison, when the network payment environment is a safe environment, a first characteristic curve y=Asinx is dynamically displayed in the display screen, and the first characteristic curve y=Asinx is presented with a small amplitude and a small magnitude of vibration. When the network payment environment is a dangerous environment, a second characteristic curve y=Bsinx is dynamically displayed in the display screen, and the second characteristic curve y=Bsinx is presented with a large amplitude and a large magnitude of vibration. In addition, under a situation in which the dangerous environment is divided into different danger levels according to the number and/or the respective categor(ies) of the detection sub-items in which risk(s) is/are detected according to the present disclosure described in the foregoing description, the representation curve setting unit 308 may set the second representation curve y=Bsinx to change in accordance with a danger level of the dangerous environment, i.e., the higher the danger level of the dangerous environment is, the larger the magnitude of fluctuation of the second representation curve y=Bsinx is.

In implementations, in order to display a change of a network transaction in real time, the dynamic display unit 310 may further issue updated information and display the updated information above the first representation curve or the second representation curve dynamically upon detecting a new change after the security detection unit 306 performs a real-time detection on transaction data that is conducted in the network payment client and/or the network payment environment. Transaction data is used as an example for illustration. When new transaction data is generated, the dynamic display unit 310 may dynamically display updated information (for example, “two new transactions”) of the newly generated transaction data above the first representation curve or the second representation curve, which is then faded away by fade-out. Alternatively, in some implementations, the dynamic display unit 310 may further issue updated information, display the updated information above the first representation curve or the second representation curve, and dynamically move the updated information from a position above the first representation curve or the second representation curve to a position below the first representation curve or the second representation curve upon detecting a new change, after the security detection unit 306 performs a real-time detection on transaction data and/or the network payment environment running in the network payment client terminal. Transaction data is still used as an example for illustration. When new transaction data is generated, the dynamic display unit 310 may first display updated information (for example “two new transactions”) of the newly generated transaction data above the first representation curve or the second representation curve dynamically, which is then dynamically moved from a position above the first representation curve or the second representation curve to a position below the first representation curve or the second representation curve until blanking out.

In this way, the dynamic display system 300 for network payment information provided in the present disclosure performs a real-time security detection on detection items related to the security of a network payment, determines the security of a network payment environment based on a detection result obtained from the security detection, and dynamically displays a corresponding representation curve on a display screen of an intelligent terminal, which has an intuitive and clear display effect and is updateable in real time, thus enhancing user experience.

In implementations, the system 300 may further include one or more processors 312, an input/output (I/O) interface 314, a network interface 316 and memory 318. The memory 318 may include a form of computer-readable media, e.g., a non-permanent storage device, random-access memory (RAM) and/or a nonvolatile internal storage, such as read-only memory (ROM) or flash RAM. The memory 318 is an example of computer-readable media as described in the foregoing description. The memory 318 may include one or more program units 320 and program data 322. The program units 320 may include the activation unit 302, the security detection unit 304, the security determination unit 306, the representation curve setting unit 308, and the dynamic display unit 310. Details of these units are not repeatedly described herein.

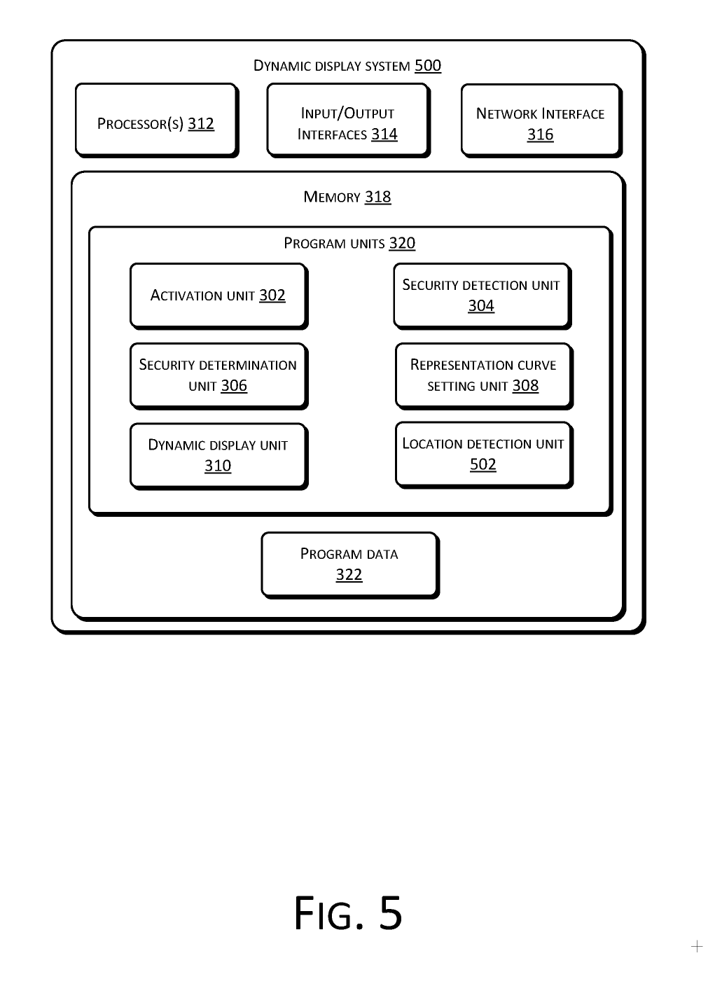

Moreover, FIG. 5 shows a schematic diagram of a dynamic display system 500 for network payment information in accordance with another embodiment of the present disclosure. As compared with the dynamic display system 300 for network payment information provided by the present disclosure in FIG. 3, the exemplary dynamic display system 500 for network payment information as shown in FIG. 5 includes an assignment of an additional setting function to the representation curve setting unit 308 and an addition of a location detection unit 502 corresponding to the additional setting function.

The representation curve setting unit 308 may further convert the first representation curve and the second representation curve into a Bézier curve as a trajectory of a touch-screen operation. In implementations, the Bézier curve is a quadratic Bézier curve, and control point(s) of the quadratic Bézier curve is/are located below the quadratic Bézier curve.

In implementations, the location detection unit 502 may be configured to detect whether the first representation curve or the second representation curve displayed dynamically by the dynamic display unit 310 is pulled. In implementations, in response to the location detection unit 502 detecting that the first representation curve or the second representation curve is pulled, the dynamic display unit 310 displays a change state after the first representation curve or the second representation curve is pulled, hides page information, and shows the updated information. In response to the location detection unit 502 detecting that the first representation curve or the second representation curve is restored, the dynamic display unit 310 displays a respective change state after the first representation curve or the second representation curve is restored, restores an original interface, and displays updated information in the original interface. Transaction data is used as an example for illustration. In practice, when new transaction data is generated, a downward pulling of the first representation curve or the second representation curve causes the first representation curve or the second representation curve to be deformed by force and arched down. At this time, original page information is hidden. The dynamic display unit 310 may dynamically display updated information of the newly generated transaction data (e.g., “a new transaction cc”, “a new transaction dd”, and “a new transaction ee”, etc.) above the first representation curve or the second representation curve according to a time sequence, which is then disappeared by fading out. When the first representation curve or the second representation curve is restored, the original page information is displayed again. However, the page information shows information that is updated, for example, a number of transactions is updated to be a sum of an original number of transactions and three new transactions (i.e., new transactions cc, dd and ee).

Furthermore, the location detection unit 502 may also be associated with the security detection unit 304. When the location detection unit 502 detects that the first representation curve or the second representation curve is restored after being pulled, the security detection unit 304 restarts the security detection on the detection items related to the network payment security and the security determination unit 306 determines the security of the network payment environment based on a detection result of the security detection performed by the security detection unit 304.

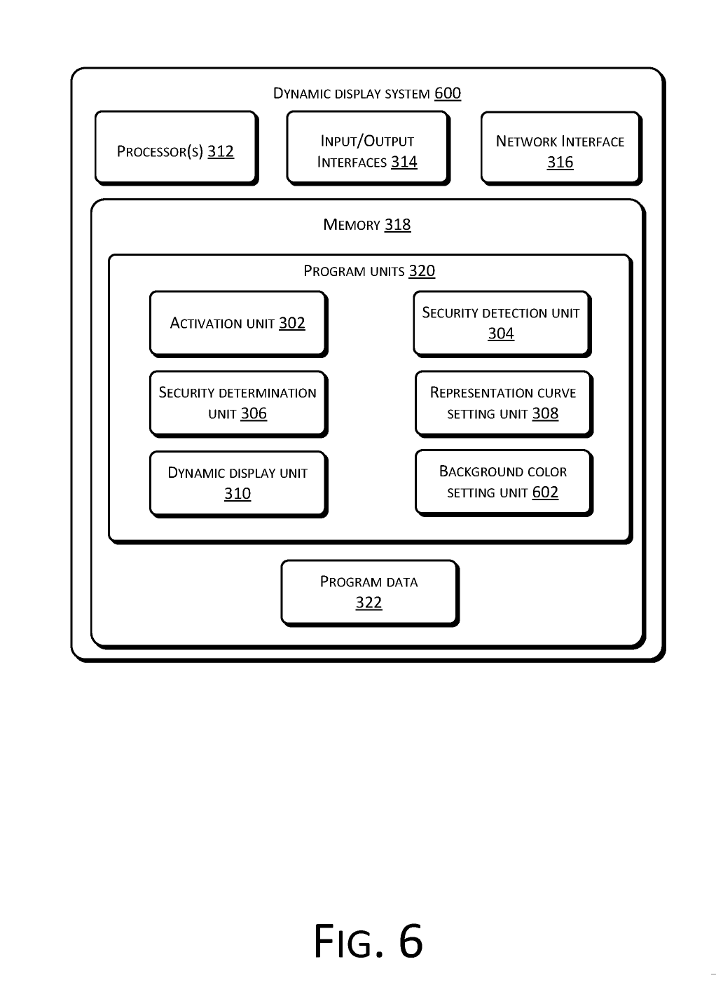

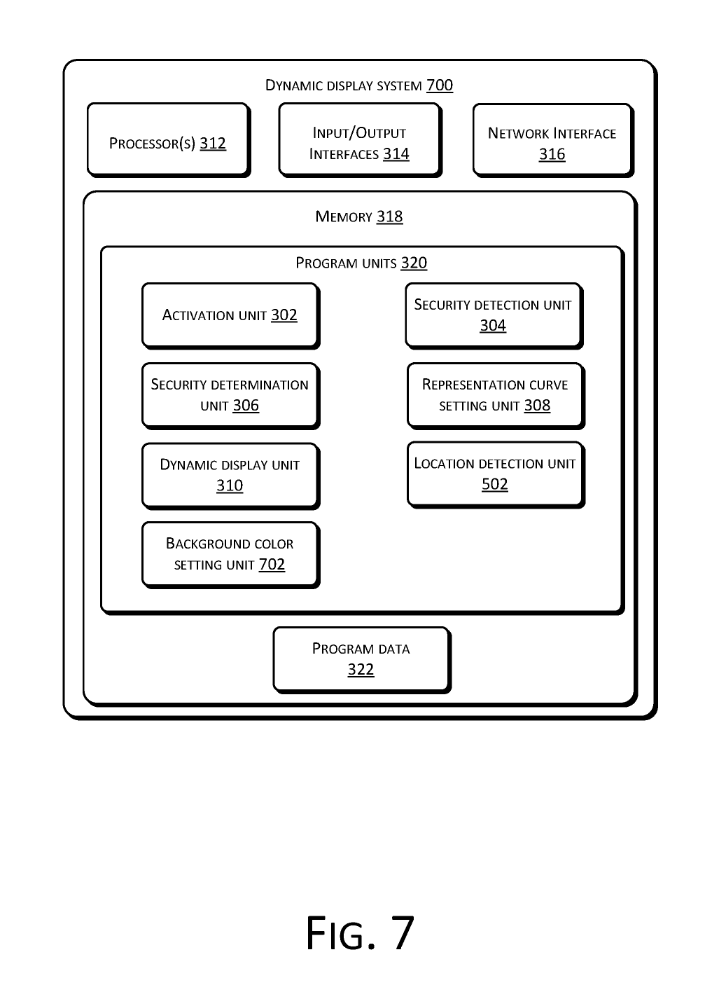

FIGS. 6 and 7 show schematic diagrams of dynamic display systems 600 and 700 for network payment information in accordance with other embodiments of the present disclosure respectively. A comparison between the dynamic display system 600 for network payment information as shown in FIG. 6 and the dynamic display system 300 for network payment information as shown in FIG. 3, and a comparison between the dynamic display system 700 for network payment information as shown in FIG. 7 and the dynamic display system 500 for network payment information as shown in FIG. 5 illustrate that the dynamic display system 600 for network payment information as shown in FIG. 6 and the dynamic display system 700 for network payment information as shown in FIG. 7 further include a background color setting unit 602 (or a background color setting unit 702), which is configured to set a first background color corresponding to the safe environment and a second background color corresponding to the dangerous environment. As such, in response to the security determination unit 306 determining that the network payment environment is the safe environment, the background color setting unit 602 (or the background color setting unit 702) provides the first background color corresponding to the safe environment and the dynamic display unit 310 displays the first background color in the display screen of the intelligent terminal. In response to the security determination unit 306 determining that the network payment environment is the dangerous environment, the background color setting unit 602 (or the background color setting unit 702) provides the second background color corresponding to the dangerous environment, and the second background color is displayed in the display screen of the intelligent terminal. In implementations, the background color setting unit 602 (or the background color setting unit 702) may set the first background color corresponding to the safe environment to be light and bright (e.g., a color such as green or blue which has a relatively short wavelength), and the second background color corresponding to the dangerous environment to be striking (e.g., a color such as orange or red which has a relatively long wavelength).

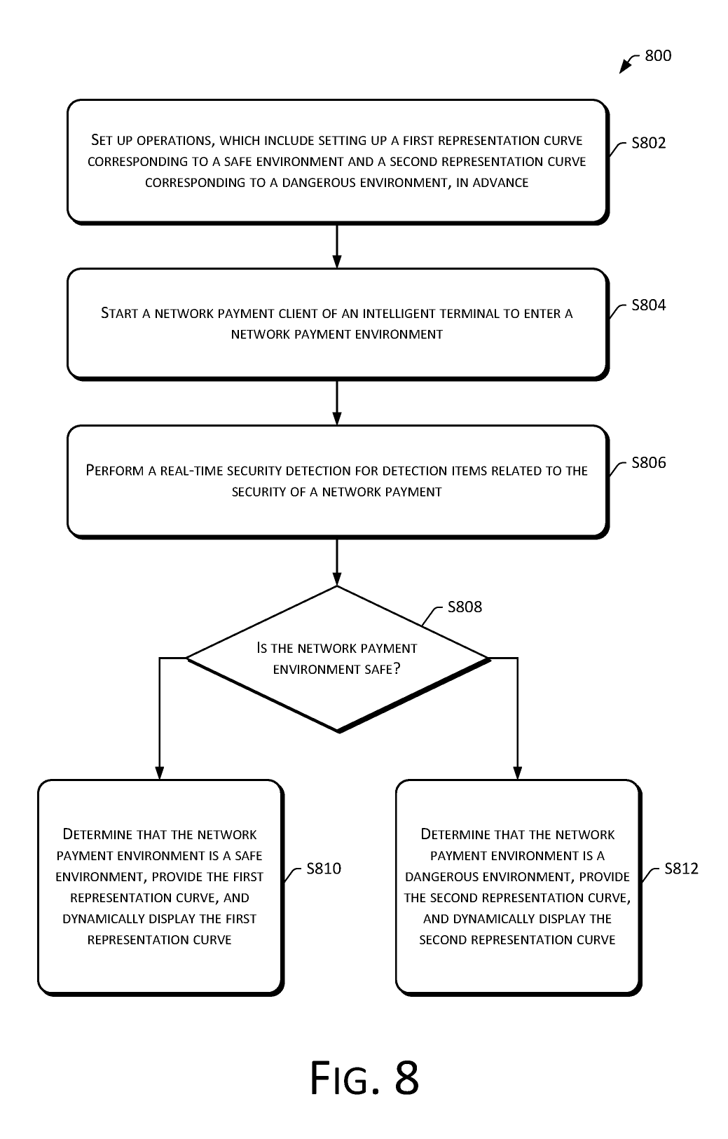

FIG. 8 shows a schematic diagram of a method 800 for dynamically displaying network payment information in accordance with an embodiment of the present disclosure.

As shown in FIG. 8, the method 800 for dynamically displaying network payment information that is provided by the present disclosure may include the following method blocks.

At S802, operations, which include setting up a first representation curve corresponding to a safe environment and a second representation curve corresponding to a dangerous environment, are configured in advance. In implementations, the preconfigured operations include at least setting representation curves. Setting the representation curves includes setting a first representation curve corresponding to a safe environment, with an expression of the first representation curve being y=Asinx, where A>0, and setting a second representation curve corresponding to a dangerous environment, with an expression of the second representation curve being y=Bsinx, where B>0 and B>A. In this way, upon comparison, when the network payment environment is a safe environment, a first characteristic curve y=Asinx is dynamically displayed in the display screen, and the first characteristic curve y=Asinx is presented with a small amplitude and a small magnitude of vibration. When the network payment environment is a dangerous environment, a second characteristic curve y=Bsinx is dynamically displayed in the display screen, and the second characteristic curve y=Bsinx is presented with a large amplitude and a large magnitude of vibration. In addition, under a situation in which the dangerous environment is divided into different danger levels according to the number and/or the respective categor(ies) of the detection sub-items in which risk(s) is/are detected according to the present disclosure described in the foregoing description, the representation curve setting unit 308 may set the second representation curve y=Bsinx to change in accordance with a danger level of the dangerous environment, i.e., the higher the danger level of the dangerous environment is, the larger the magnitude of fluctuation of the second representation curve y=Bsinx is.

In implementations, this method block may further include converting the first representation curve and the second representation curve into Bézier curves as trajectories of touch-screen operations. In implementations, a Bézier curve is a quadratic Bézier curve, and a control point of the quadratic Bézier curve is located below the quadratic Bézier curve.

In implementations, the preconfigured operations may further include setting a background color. Setting the background color may include setting a first background color corresponding to the safe environment and a second background color corresponding to the dangerous environment. In implementations, the first background color corresponding to the safe environment that is set by the background color setting unit 602 (or the background color setting unit 702) may be light and bright (for example, a color such as green or blue that has a relatively short wavelength), and the second background color corresponding to the dangerous environment may be set as striking (for example, a color such as orange or red that has a relatively long wavelength).

At S804, a network payment client of an intelligent terminal is started to enter a network payment environment. In implementations, an intelligent terminal is equipped with a network payment client for conducting a network payment. If a mobile phone is taken as an example, a network payment client for conducting a network payment is an application software APP, i.e., a mobile payment platform APP. In practice, after a user clicks on an application icon corresponding to the mobile payment platform APP in a touch-sensitive display screen, the activation unit 302 starts the mobile payment platform APP according to the present clicking operation, and displays a corresponding payment page in the touch-sensitive display screen. In general, a network payment scenario is entered by inputting an account and a login password in the payment page.

At S806, a real-time security detection is performed for detection items related to the security of a network payment. In implementations, the detection items related to the security of the network payment may include at least software loaded in the intelligent terminal and an account of a user for making the network payment. In implementations, the software loaded in the intelligent terminal may further include a virus software detection sub-item and a pirated software detection sub-item, and the account of the user for making the network payment may further include a remote login detection sub-item, a public device detection sub-item, a mobile phone binding change detection sub-item, and a password modification detection sub-item. In practice, a security detection is performed on these six detection sub-items. In other words, performing the security detection on the software loaded in the intelligent terminal includes a detection of a presence of the virus software and/or a presence of the pirated software in the software loaded in the intelligent terminal. Performing the security detection on the account of the user for making the network payment may include a detection of a presence of a remote login, a presence of a public equipment login, a presence of a binding change of a mobile phone, and/or a presence of a password modification. Apparently, it should be noted that the present embodiment merely illustrates six detection sub-items as examples, but is not limited thereto. In reality, other necessary detection sub-items may also be adjusted or added based on characteristics of the intelligent terminal, a type and security requirement(s) of the network payment.

At S808, a determination is made for the security of the network payment environment based on a detection result of the security detection. In implementations, a determination is made for the security of the network payment environment based on a comprehensive result obtained after performing the detection on the multiple sub-items that are monitored. In the present disclosure, the security of network payment environment is defined as follows: determining that the network payment environment is a safe environment when and only when no risk is found to exist in all of the above detection sub-items (i.e., the loaded software does not include any virus software and pirated software, and none of a remote login, a public equipment login, a binding change of the mobile phone and a password modification exist); otherwise, determining that the network payment environment is a dangerous environment in response to detecting that a risk exists in any one of the above detection sub-items (i.e., a virus software and/or a pirated software exist(s) in the loaded software, a remote login, a public equipment login, a binding change of the mobile phone, and/or a password modification exist(s)). Furthermore, due to a large number of detection sub-items to be detected, in practice, the present disclosure may further divide the dangerous environment into different danger levels based on a number and/or respective categor(ies) of the detection sub-items in which risk(s) is/are detected. For example, the more the number of detection sub-items having risks is, the higher the danger level corresponding to the dangerous environment is. Alternatively, certain one or more detection sub-items may have a higher weight. When a risk exists in any of these detection sub-items having a higher weight, the dangerous environment has a higher danger level.

At S810, in response to determining that the network payment environment is a safe environment, the first representation curve corresponding to the safe environment is provided, and the first representation curve is dynamically displayed on a display screen of the intelligent terminal.

At S812, in response to determining that the network payment environment is a dangerous environment, the second representation curve corresponding to the dangerous environment is provided, and the second representation curve is dynamically displayed on the display screen of the intelligent terminal.

With reference to S201, in some implementations, the preconfigured operations may further include setting a background color. Therefore, the method 800 may further include providing a first background color corresponding to a safe environment and dynamically displaying the first background color in a display screen of the intelligent terminal in response to determining that the network payment environment is the safe environment at S810; and providing a second background color corresponding to a dangerous environment and dynamically displaying the second background color in the display screen of the intelligent terminal in response to determining that the network payment environment is the dangerous environment at S812. As such, a double implication effect is obtained from a combination of a background color and a characteristic curve (a combination of a first background color and a first characteristic curve, and a combination of a second background color and a second characteristic curve), having the advantages of being intuitive and clearly legible.

In implementations, in order to display a change condition of a network transaction in real time, the method 800 for dynamically displaying network payment information provided by the present disclosure may further include a function of dynamically updating information. In implementations, a real-time detection may be performed on transaction data that is conducted in the network payment client and/or the network payment environment. After a new change is detected, updated information is issued and the updated information is displayed above the first representation curve or the second representation curve dynamically. Transaction data is used as an example for illustration. When new transaction data is generated, updated information (such as “two new transactions”) of the newly generated transaction data is dynamically displayed above the first representation curve or the second representation curve, which is then faded away by fade-out. Alternatively, in some implementations, the method 800 may further include performing a real-time detection on transaction data that is conducted in the network payment client and/or the network payment environment; and issuing updated information, displaying the updated information above the first representation curve or the second representation curve, and dynamically moving the updated information from a position above the first representation curve or the second representation curve to a position below the first representation curve or the second representation curve upon detecting a new change. Transaction data is still used as an example for illustration. When new transaction data is generated, updated information (e.g., “two new transactions”) of the newly generated transaction data is first dynamically displayed above the first representation curve or the second representation curve, which is then dynamically moved from a position above the first representation curve or the second representation curve to a position below the first representation curve or the second representation curve until being blanked out.

Furthermore, as described at S201, in implementations, the method 800 may further include converting the first representation curve and the second representation curve into Bézier curves as trajectories of respective touch-screen operations. Therefore, the method 800 may further include detecting respective motion trajectories of the first representation curve and the second representation curve, i.e., detecting whether the first representation curve and the second representation curve are pulled. In implementations, in response to detecting that the first representation curve or the second representation curve is pulled, a change state is displayed, page information is hidden and updated information is displayed after the first representation curve or the second representation curve is pulled. In response to detecting that the first representation curve or the second representation curve is recovered, a change state is displayed, an original interface is restored, and updated information is displayed in the original interface after the first representation curve or the second representation curve is recovered. Transaction data is used as an example for illustration. In practice, when new transaction data is generated, a downward pulling of the first representation curve or the second representation curve causes the first representation curve or the second representation curve to be deformed by force and arched down. At this time, original page information is hidden. Updated information of the newly generated transaction data (e.g., “a new transaction cc”, “a new transaction dd”, and “a new transaction ee”) is displayed above the first representation curve or the second representation curve dynamically according to respective times of occurrence, which is then disappeared by fading out. When the first representation curve or the second representation curve is restored, the original page information is displayed again. However, the page information shows information that is updated, for example, a number of transactions is updated to be a sum of an original number of transactions and three new transactions (i.e., new transactions cc, dd and ee).

The foregoing embodiments are used for illustrating the principles and effects of the present disclosure only, and should not be construed as limitations to the present disclosure. One skilled in the art can alter or modify the above embodiments without departing from the spirit and scope of the present disclosure. Therefore, any modifications and variations made by one of ordinary skill in the art without departing from the spirit and technical concepts disclosed by the present disclosure shall still be covered by the appended claims of the present disclosure.

What is claimed is:

1. A method comprising:
obtaining security information of a user device;
determining corresponding security display information based at least in part on the security information, the security display information including a security curve corresponding to the security information; and
providing the security display information to the user device for presentation.

2. The method of claim 1, further comprising:
obtaining a user operation associated with the security curve; and
performing a corresponding security processing operation based at least in part on the user operation.

3. The method of claim 2, wherein performing the corresponding security processing operation comprises:
updating the security information and displaying new security display information corresponding to the updated security information when the user operation corresponds to an information refresh operation; or
switching and displaying at least a part of information in the security display information when the user operation corresponds to an information switch operation.

4. The method of claim 3, wherein switching and displaying the at least part of information in the security display information comprises one or more of:
hiding at least a first part of information that is displayed in the security display information;
displaying at least a second part of information that is not displayed in the security display information; or
replacing the at least first part of information that is displayed in the security display information by the at least second part of information that is not displayed in the security display information.

5. The method of claim 2, wherein performing the corresponding security processing operation comprises:
generating an operation indication curve based at least in part on the user operation and the security curve; and
displaying the operation indication curve in a display window corresponding to the security display information.

6. The method of claim 1, wherein providing the security display information further comprises providing background information corresponding to the security information to the user device for presentation.

7. The method of claim 1, further comprising:
obtaining security event information;
generating security prompt information corresponding to the security event information; and
providing the security prompt information to the user device for presenting in a display window corresponding to the security display information.

8. The method of claim 7, wherein the security prompt information is displayed in a corresponding item in the display window.

9. The method of claim 7, wherein the security prompt information is displayed in the display window with a refresh frequency corresponding to the security event information.

10. The method of claim 1, wherein at least one of amplitude information or frequency information of the security curve corresponds to the security information.

11. An apparatus comprising:
one or more processors;
memory;
a first apparatus stored in the memory and executable by the one or more processors to obtain security information of a user device;
a second apparatus stored in the memory and executable by the one or more processors to determine corresponding security display information based at least in part on the security information, the security display information including a security curve corresponding to the security information; and
a third apparatus stored in the memory and executable by the one or more processors to provide the security display information to the user device for presentation.

12. The apparatus of claim 11, further comprising:
a fourth apparatus stored in the memory and executable by the one or more processors to obtain a user operation associated with the security curve; and
a fifth apparatus stored in the memory and executable by the one or more processors to perform a corresponding security processing operation based at least in part on the user operation.

13. The apparatus of claim 12, wherein the fifth apparatus is configured to:
update the security information and provide new security display information corresponding to the updated security information to the user device for presentation when the user operation corresponds to an information refresh operation; or
switch and display at least a part of information in the security display information when the user operation corresponds to an information switch operation.

14. The apparatus according to claim 13, wherein switching and displaying the at least part of information in the security display information comprises one or more of:
hiding at least a first part of information that is displayed in the security display information;
displaying at least a second part of information that is not displayed in the security display information; or
replacing the at least first part of information that is displayed in the security display information by the at least second part of information that is not displayed in the security display information.

15. The apparatus of claim 12, wherein the fifth apparatus is further configured to:
generate an operation indication curve based at least in part on the user operation and the security curve; and
display the operation indication curve in a display window corresponding to the security display information.

16. The apparatus of claim 11, wherein the third apparatus further provides background information corresponding to the security information to the user device for presentation.

17. The apparatus of claim 11, further comprising a sixth apparatus configured to:
obtain security event information;
generate security prompt information corresponding to the security event information; and
provide the security prompt information to the user device for presenting in a display window corresponding to the security display information, wherein the security prompt information is presented in the display window with a refresh frequency corresponding to the security event information.

18. One or more computer-readable media storing executable instructions that, when executed by one or more processors, cause the one or more processors to perform acts comprising:
obtaining security information of a user device;
determining corresponding security display information based at least in part on the security information, the security display information including a security curve corresponding to the security information; and
providing the security display information to the user device for presentation.

19. The one or more computer-readable media of claim 18, the acts further comprising:
obtaining a user operation associated with the security curve; and
performing a corresponding security processing operation based at least in part on the user operation, wherein performing the corresponding security processing operation comprises:
updating the security information and displaying new security display information corresponding to the updated security information when the user operation corresponds to an information refresh operation; or
switching and displaying at least a part of information in the security display information when the user operation corresponds to an information switch operation.

20. The one or more computer-readable media of claim 18, the acts further comprising:
obtaining security event information;
generating security prompt information corresponding to the security event information; and
providing the security prompt information to the user device for presenting in a display window corresponding to the security display information, wherein the security prompt information is presented in the display window with a refresh frequency corresponding to the security event information.
